(19) United States
(12) Patent Application Publication
(10) Pub. No.: US 2016/0101964 A1
(43) Pub. Date: Apr. 14, 2016

(54) ELEVATOR SYSTEM

(71) Applicant: INVENTIO AG, Hergiswil (CH)

(72) Inventor: Florian Dold, Root (CH)

(21) Appl. No.: 14/893,765

(22) PCT Filed: May 27, 2014
(86) PCT No.: PCT/EP2014/060873

§ 371 Date: Nov. 24, 2015

(30) Foreign Application Priority Data
May 28, 2013 (EP) 13169522.3

(51) Int. Cl. B66B 7/12; G01N 27/04; G01N 27/20; B66B 19/02

(52) U.S. Cl. CPC B66B 7/1223; B66B 19/02; G01N 27/041; G01N 27/20

(57) ABSTRACT

A method for checking a monitoring system in an elevator installation includes at least one of the steps: a) checking whether the traction carriers are connected to the monitoring device; b) checking whether the suspension devices are connected to the monitoring device; c) checking whether an electrical resistance of a traction carrier is within a range; d) checking whether a difference of an electrical resistance of a traction carrier from an electrical resistance of a traction carrier of the same suspension device is below a threshold value; and e) checking whether a difference of an electrical resistance of a traction carrier from an electrical resistance of a traction carrier of a different suspension device is below a threshold value; wherein the method is carried out before the elevator installation is commissioned after being installed.

### FIELD

The present invention relates to a method of checking a monitoring system in an elevator installation.

### BACKGROUND

Conventionally, steel cables were used in elevator installations as support means for supporting and/or driving an elevator car. According to a development of such steel cables, belt-like support means comprising tensile carriers and a casing arranged around the tensile carriers are also used. However, such belt-like support means cannot be monitored in conventional manner, because the tensile carriers, which determine a fracture load of the support means, are not visible through the casing.

For the monitoring of such tensile carriers in belt-like support means, a test current can be applied to the tensile carriers. A current flow or a current density, a voltage, an electrical resistance or an electrical conductivity is measured in the thus-formed current circuit or in several thus-formed current circuits. A conclusion about the integrity or degree of wear of the support means can be made on the basis of a variable measured in that way. If, in particular, the diameter of a tensile carrier reduces due to breakage of individual wires or due to metallic abrasion, the electrical resistance of this tensile carrier increases.

U.S. Pat. No. 7,123,030 B2 discloses such a method for determining a degree of wear of a belt-like support means. A conclusion about a breakage force of the support means can be made on the basis of a determined electrical resistance of electrically conductive tensile carriers.

However, a statement about the state of a support means can be made only during operation of the elevator installation in the case of such monitoring methods, which are described in the prior art, of the support means. Accordingly, it is desirable to generate more comprehensive data about the state of a support means.

### SUMMARY

It is therefore an object of the present invention to provide a method which can make available further relevant data with respect to the monitoring of a support means. Such a method shall, in addition, be realized by simple and economic means.

A method for checking a monitoring system in an elevator installation is proposed for fulfilling this object. The monitoring system comprises at least one support means and a monitoring device for monitoring a state of the support means, wherein the support means comprises electrically conductive tensile carriers surrounded by an electrically insulating casing. The method comprises at least one of the steps:
a) checking whether the tensile carriers are electrically connected with the monitoring device;
b) checking whether the support means are electrically connected with the monitoring device;
c) checking whether an electrical resistance of a tensile carrier or a plurality of interconnected tensile carriers lies within a range;
d) checking whether a difference of an electrical resistance of a tensile carrier or a plurality of interconnected tensile carriers from an electrical resistance of a tensile carrier or a plurality of interconnected tensile carriers of the same support means lies below a first threshold value; and
e) checking whether a difference of an electrical resistance of a tensile carrier or a plurality of interconnected tensile carriers from an electrical resistance of a tensile carrier or a plurality of interconnected tensile carriers of a different support means lies below a second threshold value;
   wherein the method is carried out before the elevator installation, after an installing action, is placed in an operation intended for the elevator installation and wherein the elevator installation is freed for the intended operation only if no deficiency was established in the checking.

Such a method for checking a monitoring system has the advantage that faults in installing the monitoring system and also deficiencies in installed material can be reliably recognized before the elevator installation is released for the intended operation. It is thereby ensured that the monitoring system, which carries out monitoring of a state of a support means during an operation of the elevator installation, is correctly installed before the elevator installation is released for the intended operation. It can thus be ensured that the monitoring device at the start of monitoring of the state of the support means of the elevator installation can determine reference values of intact and correctly connected support means, which is of substantial importance for the further course of monitoring the support means. In addition, through the proposed method it is possible to prevent incorrectly installed monitoring systems, for example support means, which are not fully connected with the monitoring device, of an elevator installation, from even being released at the outset for an intended operation of the elevator installation. This check accordingly makes possible reliable and secure monitoring of the support means in an elevator installation from the start of placing the elevator installation in operation.

In this connection, the term “installing” means that certain components of the elevator installation are newly installed, exchanged or serviced. The method proposed here can accordingly be carried out, in the case of a newly installed elevator installation, before first release thereof, or also in an already existing elevator installation at which an installing action, thus, for example, exchange of a component, is carried out.

The term “intended operation” in this connection means operation of the elevator installation for which the elevator installation is permitted and/or designed. An installing operation or a maintenance operation of an elevator installation is accordingly not an intended operation in the sense of this method.

In an exemplifying embodiment the method comprises at least two or at least three or at least four or five of the checking steps a) to e). The more checking steps are carried out, the more potential deficiencies can be excluded prior to placing the elevator installation into operation. Thus, each additional checking step increases reliability or operating safety of the elevator installation and the monitoring system thereof. In that regard, the sequence of checking steps is freely selectable. For example, the checking step a) can initially be carried out, followed by checking step b) and followed by checking step c). However, these three exemplifying checking steps can also be carried out in any other possible sequence.

In an exemplifying form of embodiment a deficiency is present in checking step a) if less than a predetermined number of tensile carriers is electrically connected with the monitoring device. In a preferred embodiment the predetermined number of tensile carriers corresponds with all tensile carriers of the elevator installation. In an alternative embodiment the predetermined number of tensile carriers corresponds with a specific proportion of all tensile carriers of the elevator installation, for example at least 40% or at least 60% or at least 80% of all tensile carriers of the elevator installation.

The checking step a) guarantees that a defined minimum number of all tensile carriers of an elevator installation is electrically connected with the monitoring device before the elevator installation is released for its intended operation. Thus, incorrectly connected or non-connected tensile carriers can be reliably recognized.

In an exemplifying embodiment a deficiency is present in checking step b) if less than a predetermined number of support means is electrically connected with the monitoring device. In an advantageous development the predetermined number of support means corresponds with all support means of the elevator installation. In an alternative embodiment the predetermined number of support means corresponds with a specific proportion of all support means of the elevator installation, for example at least 40% or at least 60% or at least 80% of all support means of the elevator installation.

Performance of the checking step b) has the advantage that can be established in reliable mode and manner how many support means are electrically connected with the monitoring device. It is thereby possible to prevent specific support means of an elevator installation from, in undesired manner, not being monitored by the monitoring device.

In an exemplifying form of embodiment a deficiency is present in the checking step c) if the electrical resistance lies outside the range. In an advantageous development the range has a lower limit corresponding with an electrical resistance of a tensile carrier or a plurality of interconnected tensile carriers with a first length smaller than a length of the tensile carriers and the range has an upper limit corresponding with an electrical resistance of a tensile carrier or a plurality of interconnected tensile carriers with a second length greater than a length of the tensile carriers.

Performance of the checking step c) has the advantage that support means incorrectly installed in the elevator installation, for example support means which are too long or too short or also support means not provided with tensile carriers, can thereby recognized. In addition, in a given case also electrical resistances linked with the monitoring device instead of support means can also be recognized. Equally, a major defect of the tensile carriers of a support means can be recognized by this monitoring step, such as, for example, a broken or seriously damaged tensile carrier.

In an advantageous development the first length is more than 40%, preferably more than 60%, particularly preferably more than 80%, of the length of the tensile carriers and the second length is less than 250%, preferably less than 167%, particularly preferably less than 125%, of the length of the tensile carriers. Through a narrower limitation of the first and second length with respect to a defined length of a tensile carrier of the elevator installation it is possible to achieve a capability of recognizing a largest possible number of incorrectly installed support means or faulty support means.

In an exemplifying form of embodiment a deficiency is present in the checking step d) if the difference lies above the first threshold value. In a preferred development the first threshold value is less than 15%, particularly preferably less than 10%, particularly preferably less than 5%, of an average or a predetermined electrical resistance of the tensile carrier or of the interconnected tensile carriers.

Performance of the checking step d) has the advantage that damage of a support means can be recognized in reliable mode and manner. It may happen, for example, that support means are stored in a shaft pit before being installed. If water collects in this shaft pit corrosive damage to the tensile carriers of the support means can arise. Such corrosive damage to the tensile carriers changes the electrical characteristics of the tensile carriers. Through the checking step d) such departures of the electrical characteristics of the individual tensile carriers can be recognized in reliable mode and manner. It can thus be prevented by the method proposed here that damaged support means in an elevator installation enter the intended operation of the elevator installation.

In an exemplifying form of embodiment a deficiency is present in checking step e) if the difference lies above the second threshold value. In an advantageous development the second threshold value is less than 15%, preferably less than 10%, particularly preferably less than 5%, of an average or a predetermined electrical resistance of the tensile carrier or the interconnected tensile carriers.

The checking step e) serves, similarly to the checking step d), for checking for damage of individual tensile carriers in the support means. Through comparison of electrical characteristics of tensile carriers of different support means it can in addition be ascertained if all tensile carriers of a support means have the same damage. Then, in particular, the same damage arises only in a comparison with tensile carriers of other support means.

The check for a difference of an electrical resistance in the checking steps d) and e) can each be carried out in different ways. For example, a direct comparison of the electrical resistances of two tensile carriers present in a check can be carried out. Alternatively thereto a difference of a tensile carrier from a mean value of a group of tensile carriers can be determined. In a further embodiment a departure from an electrical resistance of a tensile carrier towards a predetermined value can take place. Depending on the respective design of elevator installation and specification of the checking method a suitable variant can be selected here.

In an exemplifying form of embodiment at least one support means is installed or serviced in the elevator installation when the installing action is carried out. Such a method has the advantage that newly installed support means or exchange support means can be checked before the elevator installation is released for the intended operation.

In an exemplifying form of embodiment the monitoring device is serviced or installed when the installing action is carried out. Such a method has the advantage that after work on the monitoring device the monitoring system can be checked before the elevator installation is released for the intended operation.

The method disclosed here for checking a monitoring system in an elevator installation can be used in different types of elevator installation. Thus, for example, elevator installations with or without a shaft, with or without a counterweight, or elevator installations with different translation ratios can be used. Thus, any monitoring system with support means comprising electrically conductive tensile carriers enclosed by an electrically insulating casing can be checked by the method disclosed here.

### DESCRIPTION OF THE DRAWINGS

The invention is explained in more detail symbolically and by way of example on the basis of figures, in which:

FIG. 1 shows an exemplifying form of embodiment of an elevator installation;

FIG. 2 shows an exemplifying form of embodiment of a support means; and

FIG. 3 shows an exemplifying flowchart for checking a monitoring system.

### DETAILED DESCRIPTION

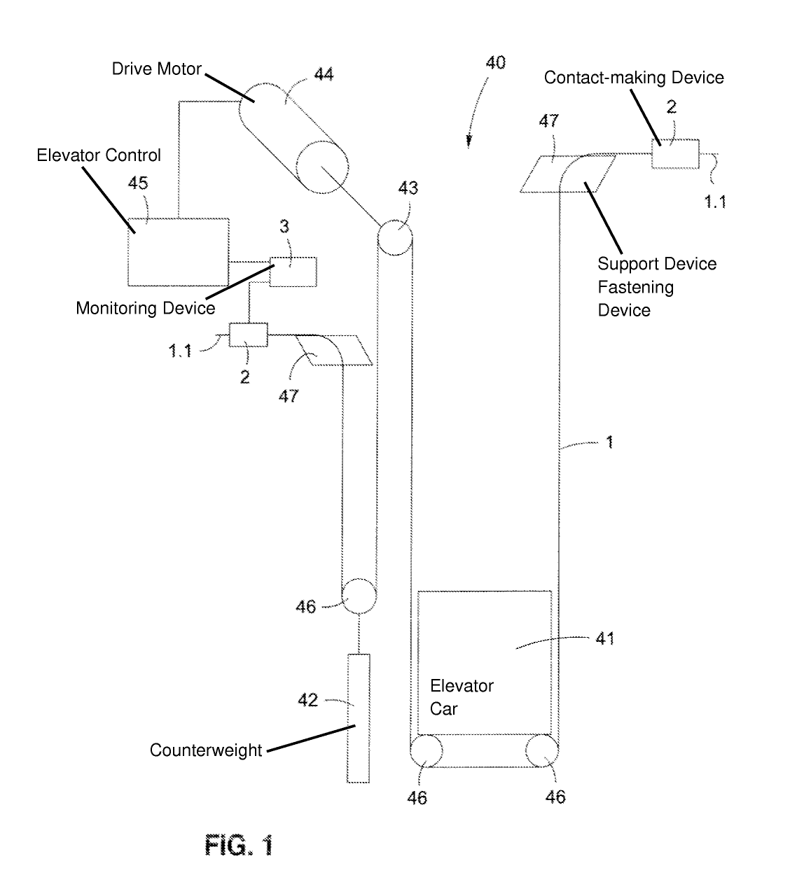

The elevator installation 40 illustrated schematically and by way of example in FIG. 1 includes an elevator car 41, a counterweight 42 and a support means or support device 1 as well as a drive pulley 43 with associated drive motor 44. The drive pulley 43 drives the support means 1 and thus moves the elevator car 41 and the counterweight 42 in opposite sense. The drive motor 44 is controlled by an elevator control 45. The car 41 is designed to receive persons or goods and transport them between floors of a building. The car 41 and counterweight 42 are guided along guides (not illustrated). In the example, the car 41 and the counterweight 42 are respectively suspended at support rollers 46. The support means 1 is in that case made fast to a first support means fastening device 47 and then initially guided around the support roller 46 of the counterweight 42. The support means 1 is then laid over the drive pulley 43, guided around the support roller 46 of the car 41 and finally connected by a second support means fastening device 47 with a fixing point. This means that the support means 1 runs over the drive 43, 44 at a speed which is higher in correspondence with a suspension factor than the car 41 and counterweight 42 move. The suspension factor is 2:1 in the example.

A free end 1.1 of the support means or device 1 is provided with a contact-making device 2 for temporary or permanent electrical contact-making with the tensile carriers and thus for monitoring the support means 1. In the illustrated example a contact-making device 2 of that kind is arranged at both ends 1.1 of the support means 1. In an alternative form of embodiment (not illustrated) only one contact-making device 2 is arranged at one of the support means ends 1.1 and the tensile carriers are electrically connected together at the other support means end 1.1. The support means ends 1.1 are no longer loaded by the tension force in the support means 1 since this tension force is already conducted beforehand into the building by way of the support means fastening devices 47. The contact-making devices 2 are thus arranged in a region, which is not rolled over, of the support means 1 and outside the loaded region of the support means 1.

In the example, the contact-making device 2 is connected at one end of the support means 1.1 with a monitoring device 3. The monitoring device 3 in that case connects the tensile carriers of the support means 1 as electrical resistances in an electrical circuit for determination of electrical resistances. The monitoring device 3 is additionally connected with the elevator control 45. A signal or a measurement value can thereby be transmitted from the monitoring device 3 to the elevator control 45 in order to take into consideration the state of the support means 1, as determined by the monitoring device 3, in a control of the elevator 40.

The illustrated elevator installation 40 in FIG. 1 is by way of example. Other suspension factors and arrangements such as, for example, elevator installations without a counterweight, are possible. The contact-making device 2 for contact-making with the support means 1 is then arranged in correspondence with the placement of the support means fastening devices 47.

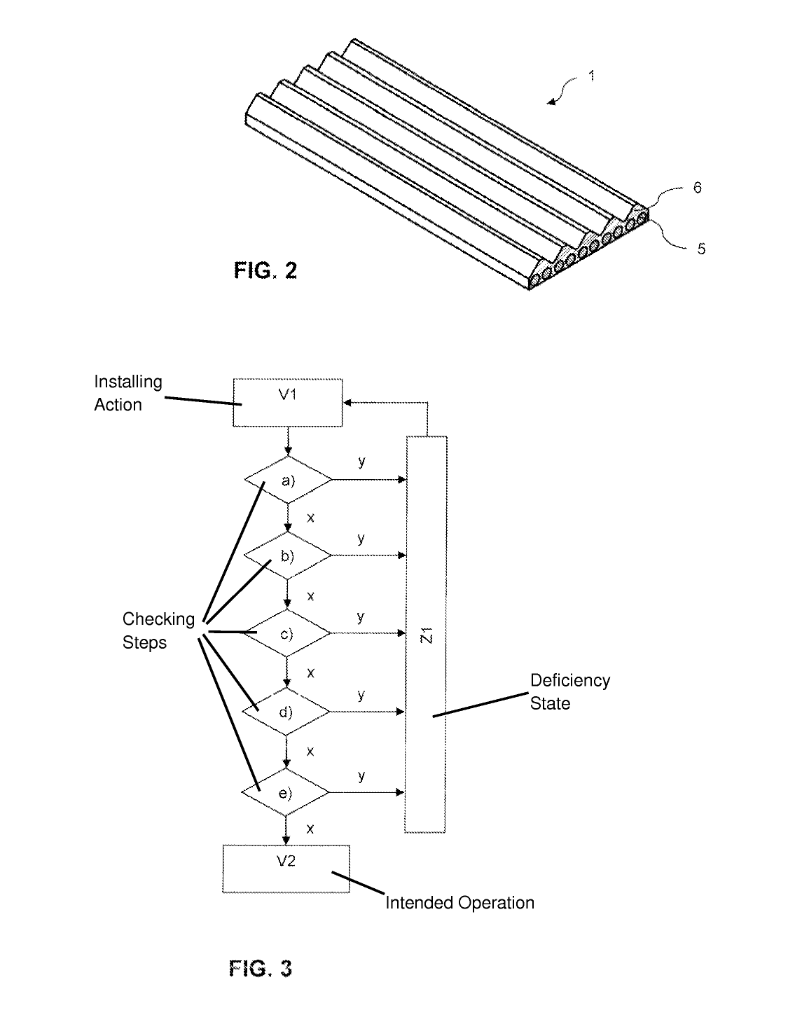

A section of an exemplifying form of embodiment of a support means 1 is illustrated in FIG. 2. The support means 1 comprises a plurality of electrically conductive tensile carriers 5 which are arranged parallel to one another and encased by a casing 6. For the electrical contact-making of the tensile carriers 5 the casing 6 can, for example, be punctured or moved or the tensile carriers can also be electrically contacted at the end by a contact-making device 2. In this example the support means is equipped with longitudinal ribs on a traction side. Such longitudinal ribs improve traction behavior of the support means 1 on the drive pulley 43 and additionally facilitate lateral guidance of the support means 1 on the drive pulley 43. However, the support means 1 can also be of different design, for example without longitudinal ribs, or with a different number or other arrangement of the tensile carriers 5. It is important for the invention that the tensile carriers 5 are formed to be electrically conductive.

A flowchart is illustrated in FIG. 3, by way of example, for performance of a method for checking a monitoring system. In this example the action V1 corresponds with an installing action, whilst the action V2 corresponds with an intended operation. The state Z1 symbolizes a deficiency. The checking steps a) to e) are all carried out in this embodiment in accordance with the series. In that case, it is decided in each checking step whether a deficiency (y) is present or whether no deficiency (x) is present. If a deficiency is established in one of the checking steps a) to e), then the check is prematurely broken off and the method is returned to the action V1, thus the installing action. Thus, in the case of a state of a deficiency of the monitoring system a correction can be undertaken before the checking steps a) to e) are carried out again.

In this embodiment no distinction is made between the different deficiencies. In an alternative embodiment (not illustrated) distinction is made between different deficiencies so that depending on the kind of deficiency the method can lead to a different action. Thus, for example, differing kinds of deficiencies can lead to differing kinds of stages of the installing procedure.

The embodiment illustrated in FIG. 3 shows merely one of a large number of different possible methods. It will be self-evident that, for example, the checking steps can take place in different number and in different sequence. The flowchart illustrated in FIG. 3 therefore serves merely for illustration of a concrete embodiment.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method of checking a monitoring system in an elevator installation, the monitoring system including at least one support device having electrically conductive tensile carriers enclosed by an electrically insulating casing and a monitoring device for monitoring a state of the support device, method comprising at least one of the steps of:
a) checking whether the tensile carriers are electrically connected with the monitoring device;
b) checking whether the at least one support device is electrically connected with the monitoring device;
c) checking whether an electrical resistance of one of the tensile carriers or a plurality of interconnected ones of the tensile carriers of the at least one support device lies within an electrical resistance range;
d) checking whether a difference of an electrical resistance of one of the tensile carriers or a plurality of interconnected ones of the tensile carriers from an electrical resistance of another one of the tensile carriers or another plurality of interconnected ones of the tensile carriers of the at least one support device lies below a first threshold value; and
e) checking whether a difference of an electrical resistance of one of the tensile carriers or a plurality of interconnected ones of the tensile carriers from an electrical resistance of another tensile carrier or another plurality of interconnected tensile carriers of a different support device lies below a second threshold value;
wherein the method is performed before the elevator installation, after an installing action, is placed in an operation intended for the elevator installation and wherein the elevator installation is freed for the intended operation only if no deficiency has been established by the checking.

17. The method according to claim 16 wherein the method includes at least two of the checking steps.

18. The method according to claim 16 wherein a deficiency is present in the checking step a) if less than a predetermined number of the tensile carriers is electrically connected with the monitoring device.

19. The method according to claim 18 wherein in the checking step a) the predetermined number of the tensile carriers is all of the tensile carriers of all of the support devices of the elevator installation.

20. The method according to claim 16 wherein a deficiency is present in the checking step b) if less than a predetermined number of all of the support devices is electrically connected with the monitoring device.

21. The method according to claim 20 wherein in the checking step b) the predetermined number of the support devices is all of the support devices of the elevator installation.

22. The method according to claim 16 wherein a deficiency is present in the checking step c) if the electrical resistance lies outside the range.

23. The method according to claim 22 wherein in the checking step c) the range has a lower limit corresponding with an electrical resistance of a tensile carrier or a plurality of interconnected tensile carriers with a first length smaller than a length of the tensile carriers and wherein the range has an upper limit corresponding with an electrical resistance of a tensile carrier or a plurality of interconnected tensile carriers with a second length larger than the length of the tensile carriers.

24. The method according to claim 23 wherein the first length is more than 40% of the length of the tensile carriers and wherein the second length is less than 250% of the length of the tensile carriers.

25. The method according to claim 23 wherein the first length is in a range of 40% to 80% of the length of the tensile carriers and wherein the second length is in a range of 250% to 125% of the length of the tensile carriers.

26. The method according to claim 16 wherein a deficiency is present in the checking step d) if the difference lies above the first threshold value.

27. The method according to claim 26 wherein in the checking step d) the first threshold value is less than 15% of an average or a predetermined electrical resistance of the tensile carrier or the plurality of interconnected tensile carriers.

28. The method according to claim 16 wherein a deficiency is present in the checking step e) if the difference lies above the second threshold value.

29. The method according to claim 28 wherein in the checking step e) the second threshold value is less than 15% of an average or a predetermined electrical resistance of the tensile carrier or the plurality of interconnected tensile carriers.

30. The method according to claim 16 including installing or servicing the at least one support device in the elevator installation during the installing action.

31. The method according to claim 16 including installing or servicing the monitoring device during the installing action.
